(19) United States
(12) Patent Application Publication
(10) Pub. No.: US 2026/0016677 A1
(43) Pub. Date: Jan. 15, 2026

(54) SYSTEMS, DEVICES, AND METHODS FOR OPTICAL MULTIMODAL SPECTRO-MICROSCOPIC IMAGING

(71) Applicant: UNM RAINFOREST INNOVATIONS, Albuquerque, NM (US)

(72) Inventors: Dongchang CHEN, Albuquerque, NM (US); You WANG, Albuquerque, NM (US)

(73) Assignee: UNM RAINFOREST INNOVATIONS, Albuquerque, NM (US)

(21) Appl. No.: 19/268,461

(22) Filed: Jul. 14, 2025

Related U.S. Application Data
(60) Provisional application No. 63/671,472, filed on Jul. 15, 2024.

(51) Int. Cl. G02B 21/36; G01N 21/64; G01N 21/65; G02B 21/12; G02B 21/16

(52) U.S. Cl. CPC G02B 21/365; G01N 21/6458; G01N 21/65; G02B 21/12; G02B 21/16

(57) ABSTRACT

A multimodal imaging system and method for multimodal imaging is disclosed. The system includes an imaging system that is configured to image a sample using two or more of imaging modes comprising a bright field imaging mode, a fluorescence imaging mode, and a Raman mapping imaging mode. The method includes arranging an imaging system to image a sample using two or more of imaging modes comprising a bright field imaging mode, a fluorescence imaging mode, and a Raman mapping imaging mode. Application of the method to solid-state batteries is disclosed.

### CROSS-REFERENCE TO RELATED APPLICATIONS

This application claims priority to U.S. Provisional Patent Application Ser. No. 63/671,472, filed Jul. 15, 2024, the entirety of which is incorporated herein by reference.

### GOVERNMENT SUPPORT

This invention was made with government support under award number 2429078 awarded by the National Science Foundation. The government has certain rights in the invention.

### TECHNICAL FIELD

The present application relates generally to microscopic imaging, particularly to systems, devices, and methods of multimodal spectro-microscopic imaging.

### BACKGROUND

The boom of Li-ion battery materials chemistry and relevant energy storage technologies have brought about a revolution in mobility, evidenced in various applications such as electrical vehicles, personal electronics, etc. However, years of commercialized applications of Li-ion batteries have also witnessed numerous safety incidents. The unsafe nature of liquid electrolyte-based Li-ion batteries is rooted in the extremely high volatility and flammability of organic ester-type electrolyte solvents. Such a grim safety issue has stimulated a newer battery technology, solid-state batteries (SSBs), which have been under spotlight and widely considered as the future of mobile energy storage. One component of an SSB is a solid-state electrolyte (SSE), which transports Li ions with a considerable conductivity in an inorganically bonded lattice/framework, which intrinsically eliminates the issue of volatility and flammability. FIG. 1 shows a schematic of an SSB and its advantage in battery safety, as well as the role of Li|SSE interface in SSBs. Moreover, the most well applied anode for SSBs is Li, which also offers the advantage of a higher energy density at the same time.

While the advantages of SSEs and SSBs are undoubtedly attractive, experimentally realizing a high performance and reliable SSB has been considered a highly difficult process. The key to realize the process largely depends on the physicochemical properties of SSE|electrode interface, i.e. how easy the Li ions can migrate through the interface to participate in the electrochemical reaction in the electrode. The word “interface” refers to both boundary area and boundary volume between two solid-state materials and includes the meaning of both interface and interphase. Especially, the Li|SSE interface has been widely considered more critical (FIG. 1), because of the possible highly complex spontaneous reaction between Li/SSE and mechanical properties of Li metal (i.e. prone to formation of dendrite, void, crack between Li/SSE, etc.). A thorough understanding of the Li|SSE interface is a premise for controlling the interface and realizing high-performance and reliable SSBs.

A microscopic technology that enables imaging of solid-state batteries based on different imaging schemes. Solid state batteries (SSBs) have been considered as the most promising alternative for conventional liquid-electrolyte-based Li-ion batteries, because of the solid-state electrolyte (SSE) intrinsically eliminates the flammability of liquid electrolyte in commercial Li-ion batteries. However, such an advantage comes with a significant shortcoming that the interface between Li and SSE requires seamless solid-solid contact without microstructural and chemical interfacial degradations. Any microstructural (e.g. dendrite, crack, void formation) or chemical (e.g. interfacial reactions, SSE degradation) will cause substantial drop of the electrochemical performance. The primary characterization technique for understanding the solid-solid interface is to use commercial metallurgical bright field microscope, which images the subject based on light scattering and light absorption. However, the technique falls in short of detecting chemical changes of the interface and thus cannot fully reveal the information of the interface.

### SUMMARY

According to examples of the present disclosure, a multimodal imaging system, the system is disclosed that comprises an imaging system that is configured to image a sample using two or more of imaging modes comprising a bright field imaging mode, a fluorescence imaging mode, and a Raman mapping imaging mode. Various additional features can be included in the multimodal imaging system including one or more of the following features. The imaging system is configured to image features of a common area of the sample based on the imaging modes. The sample is a solid-state battery. The features comprise microstructural and chemical information with a cell of the solid-state battery. The imaging system comprises one or more laser sources, one or more input optical fibers configured to provide a laser beam from the one or more laser sources to the sample, one or more movable mirrors, one or more movable beam splitters, a detector, and an output optical fiber to provide an output signal to an analyzer for analysis. A first input optical fiber of the one or more input optical fibers provides a first laser beam with a single frequency from a first laser source of the one or more laser sources to provide for fluorescence imaging when a first movable mirror of the one or more movable mirrors is in a first position. The first input optical fiber does not provide the first laser beam when the first movable mirror is in a second position. A second input optical fiber of the one or more input optical fibers provides a second laser beam from a second laser source of the one or more laser sources to provide for Raman imaging when a first movable mirror of the one or more movable mirrors is in a second position. A third movable mirror of the one or more movable mirrors are actuated in a first position for Raman imaging and a second position for fluorescence imaging. A first movable beam splitter of the one or more movable beam splitters is actuated for fluorescence imaging and for edge filtering in Raman imaging.

According to examples of the present disclosure, a method for multimodal imaging is disclosed. The method comprises arranging an imaging system to image a sample using two or more of imaging modes comprising a bright field imaging mode, a fluorescence imaging mode, and a Raman mapping imaging mode. Various additional features can be included in the method including one or more of the following features. The imaging system is configured to image features of a common area of the sample based on the imaging modes. The sample is a solid-state battery. The features comprise microstructural and chemical information with a cell of the solid-state battery. The imaging system comprises one or more laser sources, one or more input optical fibers configured to provide a laser beam from the one or more laser sources to the sample, one or more movable mirrors, one or more movable beam splitters, a detector, and an output optical fiber to provide an output signal to an analyzer for analysis. A first input optical fiber of the one or more input optical fibers provides a first laser beam with a single frequency from a first laser source of the one or more laser sources to provide for fluorescence imaging when a first movable mirror of the one or more movable mirrors is in a first position. The first input optical fiber does not provide the first laser beam when the first movable mirror is in a second position. A second input optical fiber of the one or more input optical fibers provides a second laser beam from a second laser source of the one or more laser sources to provide for Raman imaging when a first movable mirror of the one or more movable mirrors is in a second position. A third movable mirror of the one or more movable mirrors are actuated in a first position for Raman imaging and a second position for fluorescence imaging. A first movable beam splitter of the one or more movable beam splitters is actuated for fluorescence imaging and for edge filtering in Raman imaging.

According to examples of the present disclosure, a multimodal imaging system is disclosed. The system comprises a bright field imaging device; a fluorescence imaging device; and a Raman mapping imaging device, wherein two or more of the bright field imaging device, the fluorescence imaging device, and the Raman mapping imaging device are configured to image a sample. Various additional features can be included in the system including one or more of the following features. The system is configured to image features of a common area of the sample based on the various imaging modes. The sample is a solid-state battery. The features comprise microstructural and chemical information with a cell of the solid-state battery. The imaging system comprises one or more laser sources, one or more input optical fibers configured to provide a laser beam from the one or more laser sources to the sample, one or more movable mirrors, one or more movable beam splitters, a detector, and an output optical fiber to provide an output signal to an analyzer for analysis. A first input optical fiber of the one or more input optical fibers provides a first laser beam with a single frequency from a first laser source of the one or more laser sources to provide for fluorescence imaging when a first movable mirror of the one or more movable mirrors is in a first position. The first input optical fiber does not provide the first laser beam when the first movable mirror is in a second position. A second input optical fiber of the one or more input optical fibers provides a second laser beam from a second laser source of the one or more laser sources to provide for Raman imaging when a first movable mirror of the one or more movable mirrors is in a second position. A third movable mirror of the one or more movable mirrors are actuated in a first position for Raman imaging and a second position for fluorescence imaging. A first movable beam splitter of the one or more movable beam splitters is actuated for fluorescence imaging and for edge filtering in Raman imaging.

### BRIEF DESCRIPTION OF THE FIGURES

FIG. 1 shows a schematic of an SSB and its advantage in battery safety, as well as the role of Li|SSE interface in SSBs

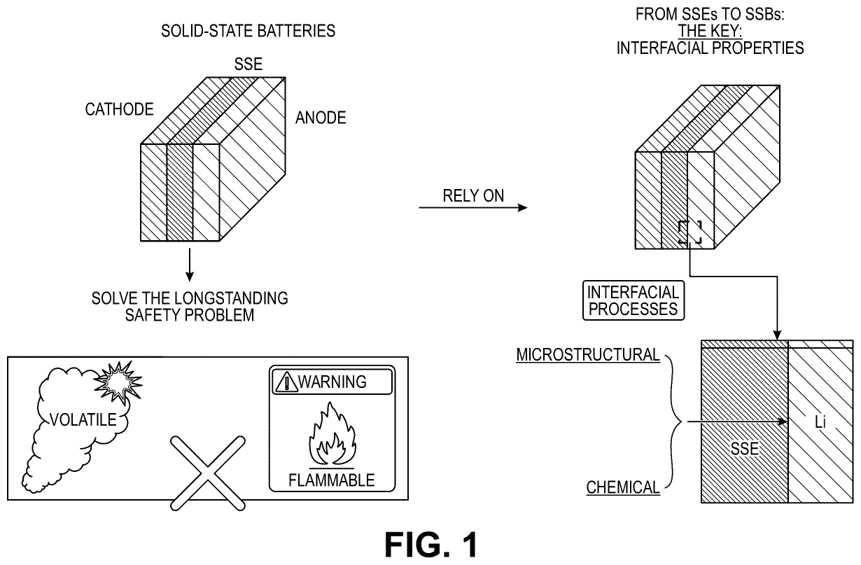

FIG. 2 shows a schematic of a system according to examples of the present disclosure.

FIG. 3 shows a schematic of the questions on the nature of Li|SSE interface and the challenges associated with answering the questions.

FIG. 4 shows a schematic of the micro-spectroscopic measurements to probe the detailed interfacial microstructural and chemical changes.

FIG. 5 shows an example of a multimodal optical fiber-based micro-spectroscopic measurement system according to examples of the present disclosure.

FIG. 6 shows an example of a multimodal optical fiber-based micro-spectroscopic measurement system according to examples of the present disclosure.

FIG. 7A shows polarized Raman spectra of Li₂ZrCl₆. FIG. 7B shows Raman spectra of halide SSEs that are used herein. The legend Zr—Y—Cl, Zr—Cl, Zr—Nb—Cl represent Li_{2.5}Y_{0.5}Zr_{0.5}Cl₆, Li₂ZrCl₆, and Li_{2.2}Zr_{0.5}Nb_{0.2}Cl_{6.4} respectively. FIG. 7C shows a PL spectrum of Li_{2.2}Zr_{0.5}Nb_{0.2}Cl_{6.4} excited by a 488 nm laser. Raman bands are shown in the inset.

FIG. 8A shows imaging results for bright field illumination of a first laser alignment card and FIG. 8B shows imaging results for photoluminescence/fluorescence illumination for the first test paper according to examples of the present disclosure. Selection of bright field and photoluminescence can be realized without alignment and computer control.

FIG. 9A shows imaging results for bright field illumination of a test optical fiber and FIG. 9B shows imaging results for photoluminescence/fluorescence illumination of the test optical fiber according to examples of the present disclosure. Selection of bright field and photoluminescence/fluorescence can be realized without alignment and computer-controlled.

FIG. 10A shows a bright field microscope image of a Li|Li_{2.2}Zr_{0.5}Nb_{0.2}Cl_{6.4} interface after 1 hour of 0.05 mA cm⁻² Li plating according to examples of the present disclosure. FIG. 10B and FIG. 10C show mapping of peak area of A_{1g} band of Zr—Cl and baseline intensity, respectively, according to examples of the present disclosure. FIG. 10D shows widefield PL imaging of the interface according to examples of the present disclosure. FIG. 12E shows Raman spectra of three positions indicated in FIG. 10A according to examples of the present disclosure.

FIG. 11 shows a schematic of a system for detecting microstructural objects and classifying chemical features via machine learning (ML) to realize correlated microstructural/chemical data stream according to examples of the present disclosure.

### DETAILED DESCRIPTION

Considering the above-discussed needs in the technology, a microscopic technology is disclosed that enables imaging of solid-state batteries based on different imaging schemes, including bright field imaging, fluorescence imaging, and Raman mapping that allows the same area of interest probed by different methods and can reveal both microstructural and chemical information of the interface. The multimodal configuration can be realized via various kinematic components that allow easy switch of optical paths. According to examples of the present disclosure, a coupled multi-energy-scale spectroscopic and microscopic analytical approach is disclosed to fundamentally understand the nature of intertwined microstructural and chemical properties of Li|SSE interface in halide based SSBs (SSE, solid-state electrolyte, SSB, solid-state batteries).

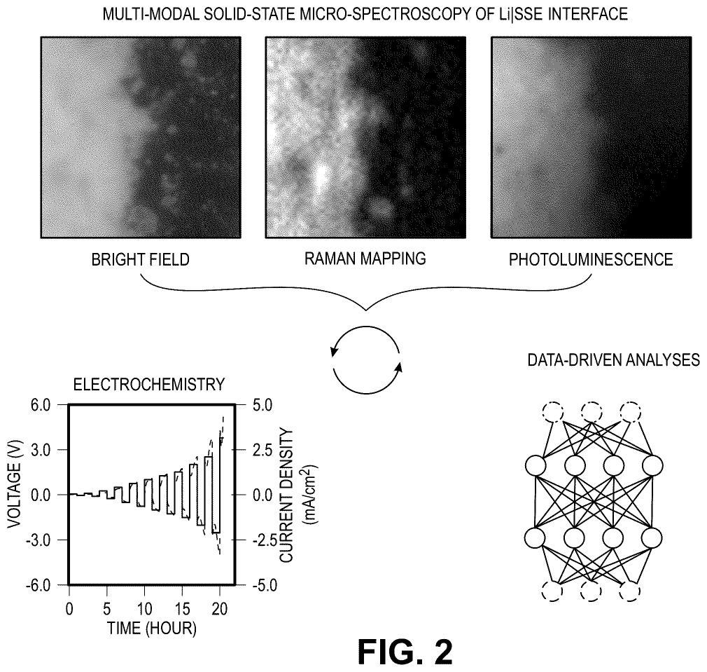

FIG. 2 shows a schematic of a system according to examples of the present disclosure. While SSBs have been considered as the future of mobile energy storage technology, electrochemical behavior of SSBs is often harrowed by various unwanted physicochemical processes at Li|SSE interface. Understanding the nature and the role of Li|SSE interfacial physicochemical processes is an indispensable task for realizing high-performance and reliable SSBs. However, current mainstream experimental platforms and data analysis methods for Li|SSE interface analysis are limited in the capability of disentangling the intertwined microstructural and chemical interfacial features and quantifying the role of these features in electrochemistry. These issues, if left unresolved, will pose a broader limitation on understanding of solid-solid interfaces, which is of critical importance for various fields, not only for SSBs. A micro-spectroscopic experiment/data analysis platform is disclosed to resolve the issues mentioned above. Halide-based SSBs, which have received a tremendous amount of attention, will be applied as the materials system used for the technique development. The approach integrates battery electrochemistry, multiple micro-spectroscopic techniques based on various light-matter interaction schemes, and data-driven analysis powered by datamining/machine learning, as shown in FIG. 2.

As described below, the electrochemical behavior of SSBs based on three selected halide SSEs, the role of SSE compositions in SSB electrochemistry, and the possible Li|SSE interfacial processes that control the electrochemistry are investigated. A correlated micro-spectroscopic data stream is used for multiple micro-spectroscopic techniques to investigate the Li|SSE interfaces and apply data driven micro-spectroscopic analysis to extract the correlation between microstructural and chemical features and dynamic evolution of the features.

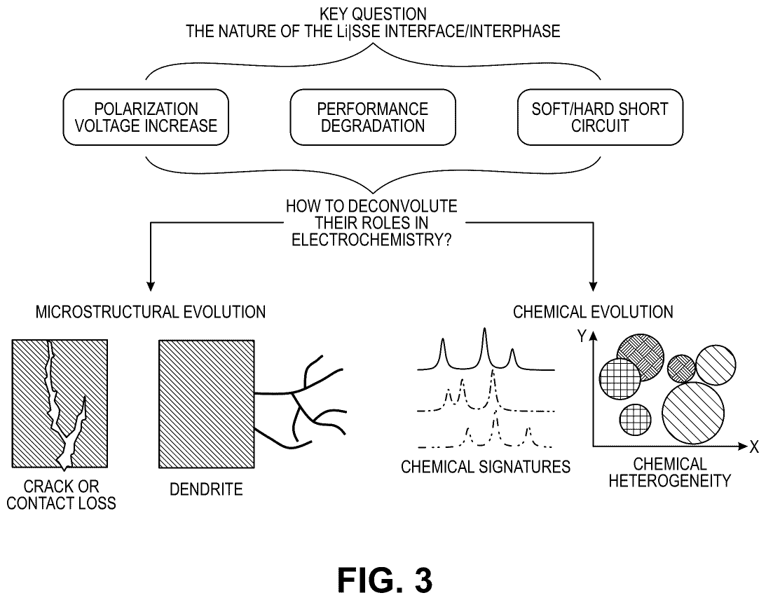

FIG. 2 shows a schematic of the questions on the nature of Li|SSE interface and the challenges associated with answering the questions. Since the rise of SSBs, characterizing the microstructural and chemical information of Li|SSE interfaces has been one of the most emphasized topics for this field, as the Li|SSE interface is often the culprit of many undesired electrochemical properties of SSBs. However, the current state-of-the-art interfacial characterization is not perfect. The dominant limitation is on the limited development of experimental platforms and data analysis methods. In most cases, current interfacial analysis either only probes microstructural changes (such as crack or dendrites) without chemical information or probes chemical changes (interfacial reaction products) without microstructural information. A generally omitted point is that microstructural changes and chemical changes are often coupled with each other, as schematically shown in FIG. 3. For example, propagation of a Li dendrite in an SSE (microstructural change) could cause reductional decomposition of the SSE (chemical change), as the Li dendrite creates new interfaces. Solely analyzing microstructural or chemical information of the interface cannot fully reveal the nature of the interface and the conclusion could be biased. Even if a thorough physicochemical investigation of the interface is made, manual analyses on the large dataset will be greatly inefficient and time-consuming in locating microstructural and chemical features and in solving the highly convoluted and entangled correlation. Also, manual analyses could easily “miss” valuable information critical for mechanistic understanding. These issues, if left unresolved, will pose a broader limitation on understanding of solid-solid interfaces, which is of critical importance for various fields, not only for SSBs.

Among all possible classes of SSE materials chemistry, advancing the understanding of Li|halide SSE interface and its role in electrochemistry is particularly worthwhile. In recent years, halide SSEs have received a tremendous amount of attention. The typical composition of a halide SSE consists of Li (the conducting ion), one or more early transition metal (M) with a d⁰ electronic structure (e.g. Zr⁴⁺), and one or two halide ions (most typical: Cl). For one or a mix of M with an average oxidation state of n*, the formula of a halide SSE can be written as LiₐMⁿ⁺Clₐ₊ₙ. The most well-known halide SSE is Li₃YCl₆, which sparked the attention of the battery materials research community. In light of the results of reported literatures, halide SSEs are more “well-rounded” compared to other classes of SSEs. Unlike oxide SSEs, which are rigid and brittle, mechanical properties of halide SSEs could easily realize more seamless ionic transport at the SSE|electrode interface. Unlike sulfide SSEs, which easily react with cathode materials, halide SSEs have been reported to be more chemically stable against commonly used cathode materials. These advantages have triggered a global race toward making better halide-based SSEs and SSBs. Despite the highly desired functionalities of halide SSEs, fundamental studies of halide SSE|Li interfaces are at a very preliminary level. Considering all these facts, developing an experimental approach that can establish correlated microstructural and chemical analysis and using halide SSEs as the sample material for this platform particularly are worthwhile.

A coupled multi-energy-scale spectroscopic and microscopic analytical approach is disclosed that can assist in understanding the nature and the role of intertwined microstructural and chemical properties of Li|SSE interface in halide-based SSBs. The approach integrates battery electrochemistry, multiple micro-spectroscopic techniques based on various light-matter interaction schemes, and data-driven analysis powered by data-mining/machine learning. The micro-spectroscopic techniques encompass conventional bright field microscopic imaging, photoluminescence/fluorescence imaging, and Raman micro-spectroscopic mapping.

A combination of multiple micro-spectroscopic techniques are used to obtain a data stream that depicts the physicochemical processes from different perspectives is suited to realize the goal of deconvoluting the complex microstructural/chemical features of the Li|SSE interface. In recent years, conventional bright field microscopic imaging has been found very effective in discerning the microstructural changes in SSBs. For chemical features, because of the structural nature of halide SSEs, Raman and photoluminescence (PL)/fluorescence spectroscopy-based imaging can provide insightful information on chemical information of the interface.

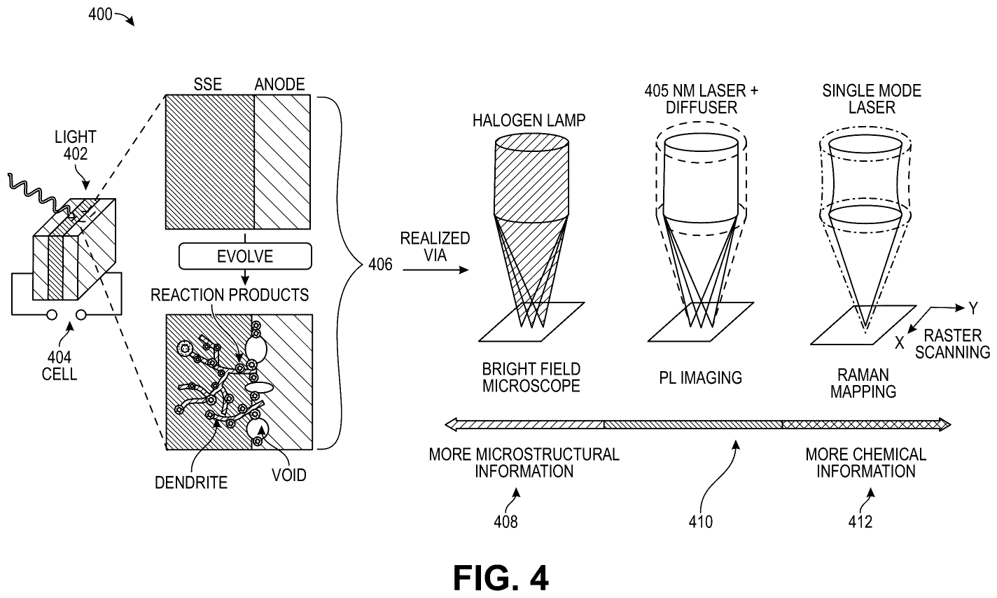

Relying on the mechanisms mentioned above, common Li|SSE interfacial phenomena, such as formation of dendrites, voids, and reaction products between Li and the SSE can be probed from different perspectives, as shown in FIG. 4. Conventional bright field imaging can be realized based on simple halogen lamp illumination. Widefield photoluminescence (PL)/fluorescence imaging can be realized via 405 nm (most commonly used laser for PL applications) and a diffuser. Raman spectroscopy can be measured via a narrow linewidth single transverse mode laser and mapping can be achieved via raster scanning the sample. Because of the multimodal micro-spectroscopic measurement, the amount of data necessitates efficient data-driven analyses to extract the information pieces of microstructural and chemical features.

FIG. 4 shows a schematic 400 of micro-spectroscopic measurements to probe the detailed interfacial microstructural and chemical changes according to examples of the present disclosure. Light 402 is directed onto sample 404, such as a battery cell, to probe structure 406, 408 of sample 404. Light 402 can be produced by a halogen lamp for bright field microscopy 408, 405 nm laser with diffuser for PL imaging 410, and a single mode laser for Raman mapping 412.

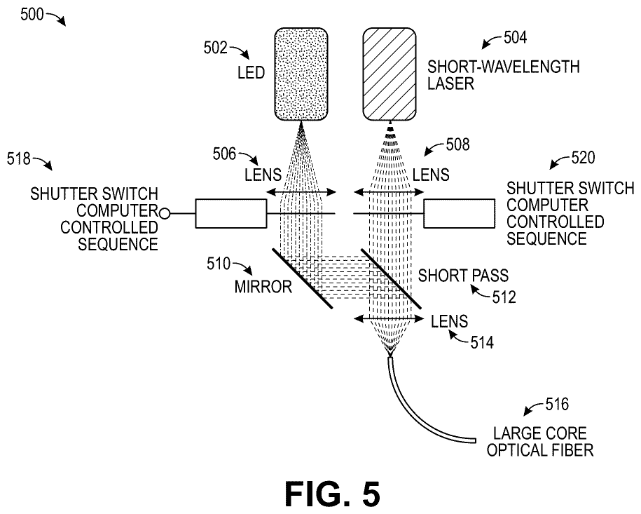

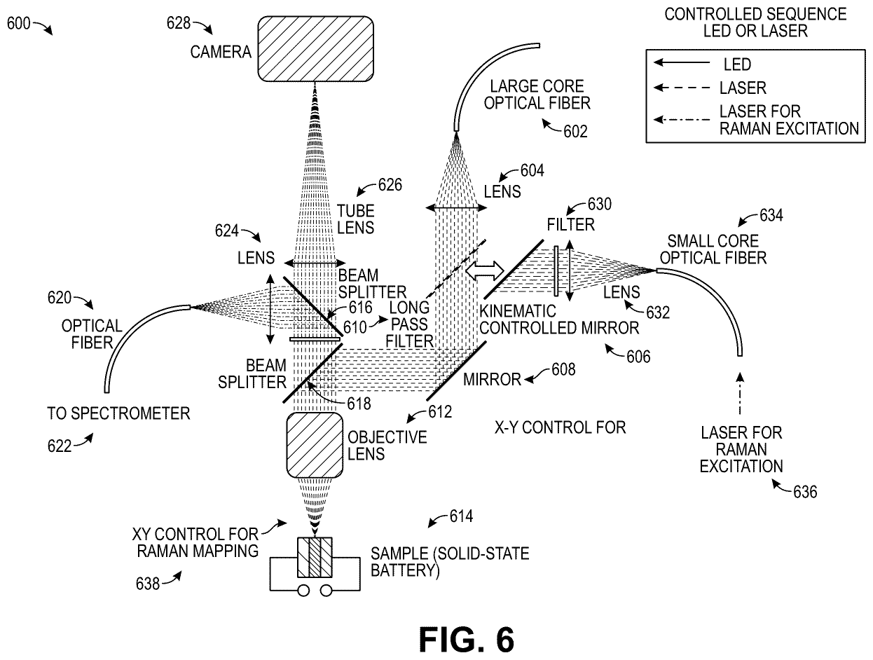

FIG. 5 shows a schematic diagram showing the coupling of LED and short-wavelength laser into a large-core optical fiber according to examples of the present disclosure. The coupling is controlled by the shutter switch sequence. FIG. 6 shows a schematic diagram of the spectroscopic/microscopic acquisition according to examples of the present disclosure. The multimodal configuration is realized via various kinematic components that allow easy switch of optical paths. The multimodal configuration is based on a simple fiber-optics-based illumination system, as shown in FIG. 5 and FIG. 6. FIG. 5 shows the fiber coupling scheme for a LED (for bright field illumination, typical 6000K) and a short-wavelength laser (for photoluminescence/fluorescence illumination, typical 405 nm). The two beams can be coupled into the same large-core optical fiber. The on/off of the two beams can be controlled via two solenoid-controlled shutters, respectively. By using an alternating-like shutter sequence, the large core optical fiber can transmit the white light and short-wavelength laser in an alternating fashion and illuminate the sample (i.e. a solid-state battery) in a controlled sequence (FIG. 6). The photoluminescence/fluorescence and brightfield microscopic image will be acquired by the camera as the same sequence of shutter control. Alternatively, a fiber-coupled single frequency laser (typical 488, 532, 561, 633, 671, or 785 nm) is used to excite Raman spectra. The beam path of the single frequency laser and LED/short-wavelength laser is controlled by a kinematic controlled mirror (FIG. 5 and FIG. 6). Raman mapping is acquired via XY scanning the sample stage. A beamsplitter is used to survey the spectrum (reflected/scattered white light, photoluminescence/fluorescence, or Raman) besides camera imaging, as shown in FIG. 5 and FIG. 6.

In particular, FIG. 5 shows an example of a multimodal optical fiber-based micro-spectroscopic measurement system 800 according to examples of the present disclosure. System 500 includes LED 502 that produces light that is directed through lens 506 and reflected by mirror 510. Short-wavelength laser 504 produces light that is directed through lens 508 and short pass filter 512. Light from LED 502 and short-wavelength laser 504 is then combined by short pass filter 512, directed through lens 814 and onto optical fiber 516 (e.g., large core optical fiber). Computer controlled shutter switch 518 is arranged between lens 506 and mirror 510 to control the timing of when light from LED 502 reaches mirror 510. Computer controlled shutter switch 520 is arranged between lens 508 and short pass filter 512 to control whether the light from LED 502 or the light from laser 504 reaches lens 514.

In particular, FIG. 6 shows an example of a multimodal optical fiber-based micro-spectroscopic measurement system 600 according to examples of the present disclosure. System 600 includes optical fiber 602 (e.g., large core optical fiber, also shown in FIG. 5 as 516) that directs light through lens 604 and onto kinematic controlled mirror 606. For example, the large core optical fiber can be about 1000-1500 micrometers in diameter and the small core optical fiber can be about 9-50 micrometers in diameter. When kinematic controlled mirror 606 is not in the optical path of the light from lens 604, the light is directed onto mirror 608 that reflects the light through long pass filter 610 that is then split by beam splitter 618. The reflected light from beam splitter 618 is directed through objective lens 612 and onto sample 614. For example, sample 614 is a solid-state battery with the cross-section of cathode/electrolyte/anode exposed to the incoming light. Sample 614 can be arranged on mount 638 that can actuate sample 614 in one or more degrees of freedom. Light is reflected/scattered from sample 614 and directed back through objective lens 612, through beam splitter 618, reflected by beam splitter 616, to lens 624, through optical fiber 620 to spectrometer 622. Light is also reflected from sample 614 and directed back through objective lens 612, through beam splitter 618, through beam splitter 616, through tube lens 626 to camera 628. When kinematic controlled mirror 606 is in the optical path of the light from lens 604, the laser from optical fiber 634 (e.g., small core optical fiber) for Raman excitation is filtered by filter 630, reflected by kinematic controlled lens 606, lens 608, reflected by beam splitter 618, directed through objective lens 612 and onto sample 614. Light is reflected/scattered from sample 614 and directed back through objective lens 612, through beam splitter 618, reflected by beam splitter 616, to lens 624, through optical fiber 620 to spectrometer 622.

For example, in operation, optical fiber 602 (e.g., large core optical fiber) can be coupled to an optical source, such as a LED that is configured to provide bright field illumination, typical 3000-6000K or a short-wavelength laser that is configured to provide photoluminescence/fluorescence illumination, typical 405 nm. The LED or the laser can be coupled to optical fiber 602 and controlled via one or more solenoid-controlled shutters, respectively, that are shown in FIG. 5. By using an alternating-like shutter sequence, optical fiber 602 can transmit the white light and short-wavelength laser in an alternating fashion and illuminate sample 614 (i.e. a solid-state battery) in a controlled sequence. When the LED illuminates sample 614 via optical fiber 602, brightfield imaging is conducted. When the laser illuminates sample 614 via optical fiber 602, photoluminescence/fluorescence imaging is conducted. Optical fiber 634 (e.g., small core optical fiber) can be coupled to a single frequency laser 636 for Raman spectra and spectral imaging. When the single frequency laser 636 illuminates sample 614 via optical fiber 634, Raman spectral measurement and spectral imaging are conducted.

The multimodal imaging can be made by the following configurations.

Bright field. Movable mirror is at position 1. LED 502 is coupled to optical fiber 516/602 (i.e., large-core fiber), controlled by the shutter 518 (shown in FIG. 5). The light illuminates sample 614 via beam splitter 618. The reflected light passes through beam splitter 618, pass through long pass filter 610, split by beamsplitter 616, focus on optical fiber 620 through lens 624 and connected to spectrometer 622 for analysis and focus on camera 628.

Photoluminescence or Fluorescence. Movable mirror 606 is at position 1. Laser 504 is coupled to optical fiber 516/602, controlled by the shutter 520 (shown in FIG. 5). The light illuminates sample 614 via beam splitter 618. The reflected light pass through long pass filter 610, passes through beam splitter 616, focus on an optical fiber connected to an analyzer and focus on camera 628.

Raman imaging. Movable mirror 606 is at position 2. Laser 636 is coupled to a small optical fiber 634. The light illuminates sample 614 via beam splitter 618. The reflected light passes through long pass filter 610, passes through beam splitter 616, focus on optical fiber 620 through lens 624 connected to spectrometer 622 for analysis and focus on camera 628. The imaging is realized by raster scanning the XY stage, as shown at 638.

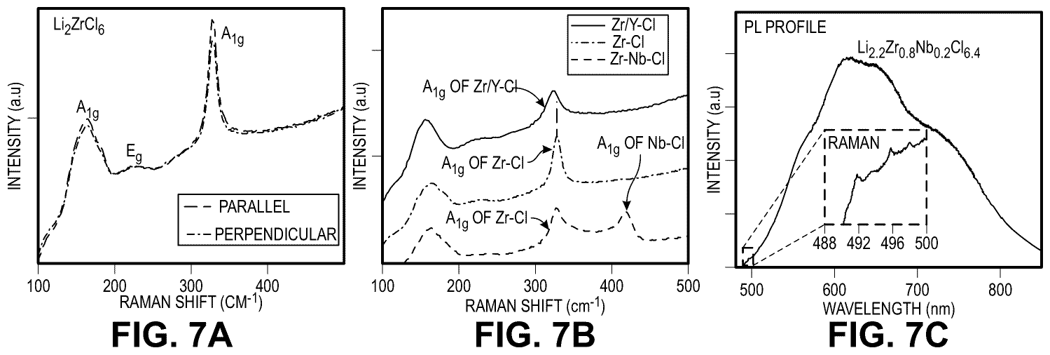

FIG. 7A, FIG. 7B, and FIG. 7C show example Raman spectra collected by the system according to examples of the present disclosure. FIG. 7A shows polarized Raman spectra of Li₂ZrCl₆. FIG. 7B shows Raman spectra of halide SSEs that are used herein. The legend Zr—Y—Cl, Zr—Cl, Zr—Nb—Cl represent Li_{2.5}Y_{0.5}Zr_{0.5}CO₆, Li₂ZrCl₆, and Li_{2.2}Zr_{0.5}Nb_{0.2}Cl_{6.4} respectively. FIG. 7C shows a PL spectrum of Li_{2.2}Zr_{0.5}Nb_{0.2}Cl_{6.4} excited by a 488 nm laser. Raman bands are shown in the inset. The feasibility of Raman and PL-based analyses for halide SSEs is shown in FIG. 7A, FIG. 7B, and FIG. 7C. FIG. 7A shows polarized Raman spectra of Li₂ZrCl₆. The band at the highest Raman shift and the highest intensity is significantly polarized, corresponding to A_{1g} symmetry. Upon Y substitution (Li_{2.5}Y_{0.5}Zr_{0.5}Cl₆), the A_{1g} band demonstrate a considerable broadening and redshift (i.e. A_{1g} becomes a mix of Zr/Y—Cl vibration). Upon Nb substitution (Li_{2.2}Zr_{0.5}Nb_{0.2}Cl_{6.4}), a new band appears, corresponding to A_{1g} of Nb—Cl vibration. FIG. 7C shows a PL spectrum of Li_{2.2}Zr_{0.8}Nb_{0.2}Cl_{6.4} (488 nm excitation). The PL spectrum spans both visible and near infrared regions with a high intensity, allowing feasible wide-field PL imaging. The Raman features can be seen in the wavelength region close to the excitation wavelength (i.e. low Raman shift).

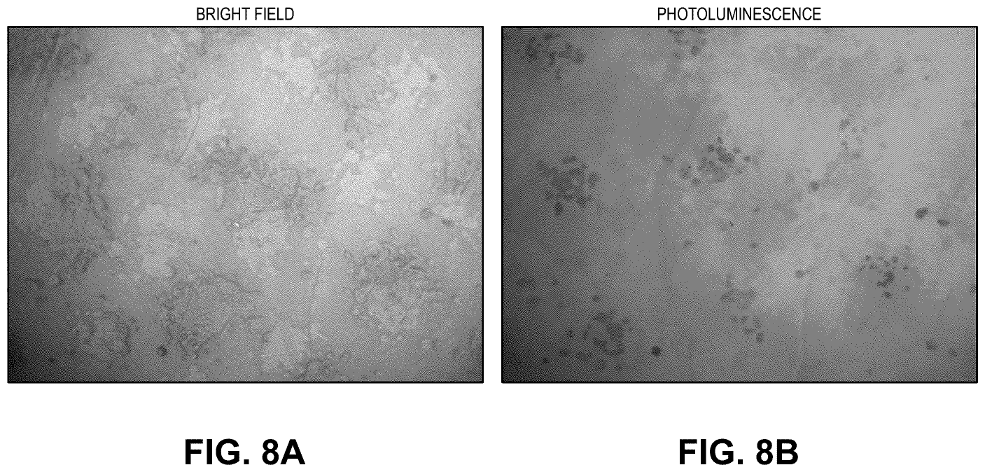

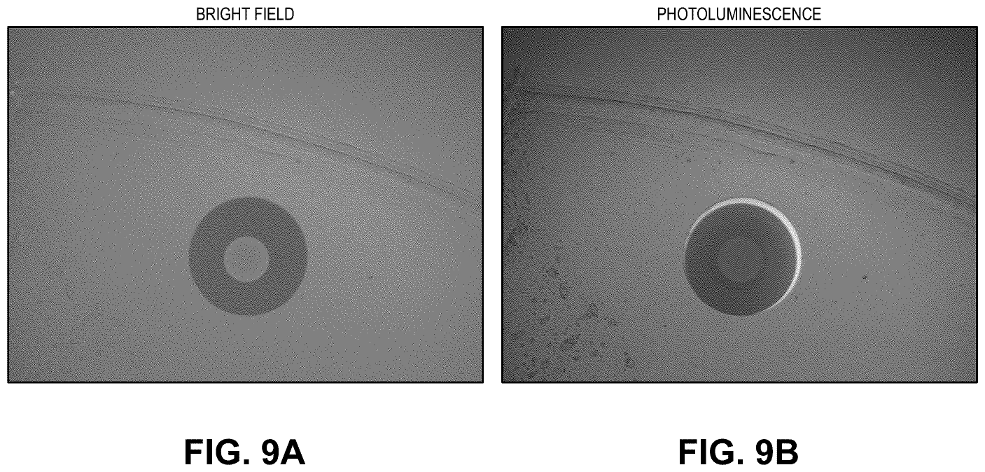

FIG. 8A, FIG. 8B, FIG. 9A, and FIG. 9B show the example imaging results of the system according to examples of the present disclosure. FIG. 8A shows imaging results for bright field illumination of a laser alignment card and FIG. 8B shows imaging results for photoluminescence/fluorescence illumination for the first test paper according to examples of the present disclosure. The bright filed image can reveal all the microstructure details of the sample, showing all the boundary and contours of the pigment, similar to the capability of common metallurgical microscopes. The photoluminescence/fluorescence image shows the strong emission of the background and reveals the contrast of pigments based on PL emission, similar to the capability of common fluorescence microscopes. FIG. 9A shows imaging results for bright field illumination of a test optical fiber connector and FIG. 9B shows imaging results for photoluminescence/fluorescence illumination of the test optical fiber connector according to examples of the present disclosure. The brightfield image shows all microstructure of the fiber and the connector, similar to the capability of common metallurgical microscopes. The photoluminescence/fluorescence image shows the strong green emission of the epoxy in the fiber connector, which cannot be feasibly seen in the brightfield microscope. In FIG. 8-9, selection of bright field and photoluminescence/fluorescence can be switched quickly by the computer-controlled shutter without changing parts or optical alignment, based on the diagram shown in FIG. 5-6. The combination of both imaging techniques for the same field of view without part change or optical alignment can reveal more details of the sample with a high efficiency, than using a single technique or using two techniques separately.

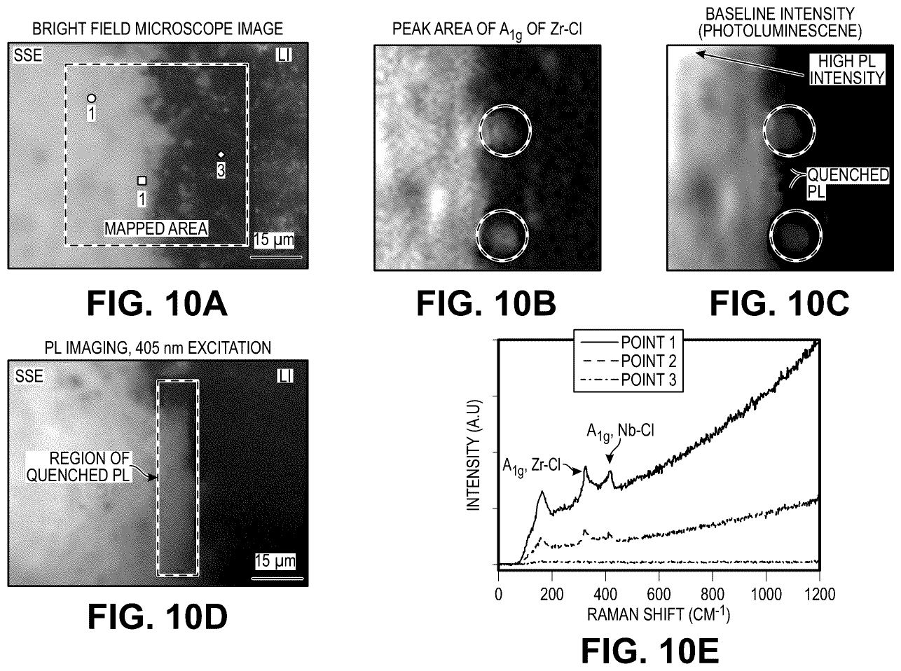

FIG. 10A, FIG. 10B, FIG. 10C, FIG. 10D, and FIG. 10E show the application of the system to solid-state battery samples according to examples of the present disclosure. FIG. 10A shows a bright field microscope image of a Li|Li_{2.2}Zr_{0.8}Nb_{0.2}Cl_{6.4} interface after 1 hour of 0.05 mA cm⁻² Li plating. FIG. 10B and FIG. 10C show mapping of peak area of A_{1g} band of Zr—Cl and baseline intensity, respectively. FIG. 10D shows widefield PL imaging of the interface. FIG. 10E shows Raman spectra of three positions indicated in FIG. 10A. Relying on the spectroscopic properties of the SSEs shown in FIG. 10A, FIG. 10B, and FIG. 10C, multimodal microscopic imaging experiments were conducted. FIG. 10A shows a bright field image of an Li|Li_{2.2}Zr_{0.5}Nb_{0.2}Cl_{6.4} interface after 1 hour of 0.05 mA cm⁻² Li plating. The bright field image directly demonstrates the non-uniform Li plating. Based on the sample region, point-by-point Raman mapping experiments were performed. The distribution of peak area of A_{1g} of Zr—Cl (312-350 cm⁻¹) and the baseline intensity, which represent photoluminescence/fluorescence, are mapped and shown in FIG. 10B and FIG. 10C respectively. The dark regions represent Li (i.e. absence of Zr—Cl vibration and PL). In the boundary region between SSE and Li, while the intensity of A_{1g} Zr—Cl Raman band and PL intensity are both lower than those of bulk SSE, quench of PL intensity of the boundary region is more significant (FIG. 10B and FIG. 10C, compared in dashed circles). Such an effect is illustrated in the spectra shown in FIG. 10E, corresponding to three sampled points shown in FIG. 10A. Intensity of A_{1g} of Zr—Cl, A_{1g} of Nb—Cl, and baseline (i.e. PL) at point 2 is 54%, 40%, and 31% of those of point 1, respectively. It suggests the Nb—Cl bond is more prone to reductive dissociation caused by Li contact, which also greatly quenches the PL intensity. Point 3 is completely absent of any Raman and PL features, corresponding to the dark region in mapping. Moreover, the PL intensity can be directly imaged via wide-field PL imaging (shown in FIG. 10D). A region of quenched PL intensity is observed at the Li|SSE boundary, which is consistent with the point-to-point PL imaging. The preliminary data revealed rich details of Li|SSE interface and demonstrate several classes of microstructural and chemical features.

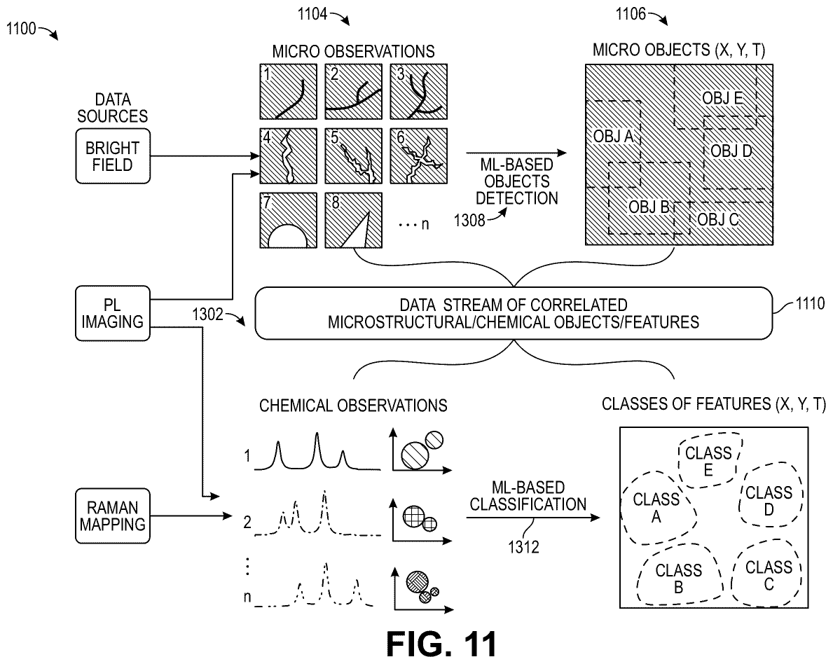

FIG. 11 shows a schematic of a system 1100 for detecting microstructural objects and classifying chemical features via machine learning (ML) to realize correlated microstructural/chemical data stream according to examples of the present disclosure. Micro-spectroscopic techniques are used to characterize Li|SSE interfaces for all three types of halide SSE compounds. Technically, after the Li|SSE|Li symmetric cell (with Cu current collector) is fabricated via a hydraulic press, the cell will be placed in the operando setup, which is based on a perfluoroalkoxy (PFA)-body Swagelok cell with an opening machined on the side for optical signal acquisition. The Swagelok cell will be clamped using a pressure of ˜5-10 Mpa. During the Li stripping/plating experiment, the bright field and PL image acquisition will be performed synchronously. After each cycle of plating/stripping, Raman spectral mapping will be conducted. After the data acquisition at 1102, data-driven microspectroscopic analyses will be conducted, with the guidance of the host, to disentangle the correlation between microstructural and chemical features of Li|SSE interface, as shown at 1104. Microstructural data, as shown at 1106, as a function of location (x,y) and time (t), will be primarily based on bright field imaging. PL imaging will also be used as a reference for microstructural data. Each microstructural feature, either a crack, a void, or a dendrite, has an easily recognizable and distinctive shape. Machine learning, as shown at 1108, aided by Mask Region-Based Convolutional Neural Networks (R-CNN) algorithm, can be used to detect each microstructural feature and label each feature as an individual object. Optical microscopy images with well-defined microstructural features can be applied as training sets. Chemical evolution data has two components, spectroscopy and spectral imaging. Spectral imaging includes both live PL images and Raman mapping data. Each spectral feature may have a distinctive spatial distribution pattern. Common features may include reduced M-Cl vibration, formation of other halide species, quenched PL intensity, etc. Spatial distribution of various spectral features may overlap with each other. These chemical features can be categorized to different “classes,” as shown at 1112. Each class represents a “cluster” of chemical species. This process can be realized by a machine learning-based classification algorithm. Multi-relation associate rule learning can be used to find the correlations between evolution of microstructural objects and classes of chemical features. The confidence level of correlation between each class of chemical features and each microstructural object can demonstrate the coupling between microstructural and chemical evolution. Based on the analysis mentioned above, a data stream of correlated microstructural objects/chemical features can be obtained, as shown at 1110.

The description of the different illustrative embodiments has been presented for purposes of illustration and description, and may be not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected may be chosen and described in order to best explain the principles of the embodiments, the practical application, and to enable others of ordinary skill in the art to understand the disclosure for various embodiments with various modifications as may be suited to the particular use contemplated.

While the foregoing disclosure has been described in some detail by way of illustration and example for purposes of clarity and understanding, it will be clear to one of ordinary skill in the art from a reading of this disclosure that various changes in form and detail can be made without departing from the true scope of the disclosure and may be practiced within the scope of the appended claims. For example, all the methods, systems, and/or component parts or other aspects thereof can be used in various combinations. All patents, patent applications, websites, other publications or documents, and the like cited herein are incorporated by reference in their entirety for all purposes to the same extent as if each individual item were specifically and individually indicated to be so incorporated by reference.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein.

While the present teachings have been illustrated with respect to one or more implementations, alterations and/or modifications can be made to the illustrated examples without departing from the spirit and scope of the appended claims. In addition, while a particular feature of the present teachings may have been disclosed with respect to only one of several implementations, such feature may be combined with one or more other features of the other implementations as may be desired and advantageous for any given or particular function. As used herein, the terms “a”, “an”, and “the” may refer to one or more elements or parts of elements. As used herein, the terms “first” and “second” may refer to two different elements or parts of elements. As used herein, the term “at least one of A and B” with respect to a listing of items such as, for example, A and B, means A alone, B alone, or A and B. Those skilled in the art will recognize that these and other variations are possible. Furthermore, to the extent that the terms “including,” “includes,” “having,” “has,” “with,” or variants thereof are used in either the detailed description and the claims, such terms are intended to be inclusive in a manner similar to the term “comprising.” Further, in the discussion and claims herein, the term “about” indicates that the value listed may be somewhat altered, as long as the alteration does not result in nonconformance of the process or structure to the intended purpose described herein. Finally, “exemplary” indicates the description is used as an example, rather than implying that it is an ideal.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompasses by the following claims.

The examples set forth herein represent the necessary information to enable those skilled in the art to practice the embodiments and illustrate the best mode of practicing the embodiments. Upon reading the description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation(s) depicted in the figures.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

What is claimed is:

1. A multimodal microscopic imaging system, the system comprising;
an imaging system that is configured to image a sample using two or more of imaging modes comprising a bright field imaging mode, a fluorescence imaging mode, and a Raman mapping imaging mode.

2. The system of claim 1, wherein the imaging system is configured to image features of a common area of the sample based on the imaging modes.

3. The system of claim 1, wherein the sample is a solid-state battery.

4. The system of claim 3, wherein the features comprise microstructural and chemical information with a cell of the solid-state battery.

5. The system of claim 1, wherein the imaging system comprises one or more laser sources, one or more light-emitting diode light sources, one or more input optical fibers configured to provide a laser beam from the one or more laser sources to the sample, one or more movable mirrors, one or more movable beam splitters, a detector, and an output optical fiber to provide an output signal to an analyzer for analysis.

6. The system of claim 5, wherein a first input optical fiber of the one or more input optical fibers provides a first laser beam with a single frequency from a first laser source of the one or more laser sources to provide for fluorescence imaging when a first movable mirror of the one or more movable mirrors is in a first position.

7. The system of claim 6, wherein the first input optical fiber does not provide the first laser beam when the first movable mirror is in a second position.

8. The system of claim 5, wherein a second input optical fiber of the one or more input optical fibers provides a second laser beam from a second laser source of the one or more laser sources to provide for Raman imaging when a first movable mirror of the one or more movable mirrors is in a second position.

9. The system of claim 1, further comprising one or more switches for controlling imaging between bright field illumination mode and fluorescence imaging mode.

10. The system of claim 5, wherein a first movable beam splitter of the one or more movable beam splitters is actuated for bright field/fluorescence imaging and for edge filtering in Raman imaging.

11. A method for multimodal imaging, the method comprising;
arranging an imaging system to image a sample using two or more of imaging modes comprising a bright field imaging mode, a fluorescence imaging mode, and a Raman mapping imaging mode.

12. The method of claim 11, wherein the imaging system is configured to image features of a common area of the sample based on the imaging modes.

13. The method of claim 11, wherein the sample is a solid-state battery.

14. The method of claim 13, wherein the features comprise microstructural and chemical information with a cell of the solid-state battery.

15. The method of claim 11, wherein the imaging system comprises one or more laser sources, one or more input optical fibers configured to provide a laser beam from the one or more laser sources to the sample, one or more movable mirrors, one or more movable beam splitters, a detector, and an output optical fiber to provide an output signal to an analyzer for analysis.

16. The method of claim 15, wherein a first input optical fiber of the one or more input optical fibers provides a first laser beam with a single frequency from a first laser source of the one or more laser sources to provide for fluorescence imaging when a first movable mirror of the one or more movable mirrors is in a first position.

17. The method of claim 16, wherein the first input optical fiber does not provide the first laser beam when the first movable mirror is in a second position.

18. The method of claim 15, wherein a second input optical fiber of the one or more input optical fibers provides a second laser beam from a second laser source of the one or more laser sources to provide for Raman imaging when a first movable mirror of the one or more movable mirrors is in a second position.

19. The method of claim 11, further comprising controlling imaging between bright field illumination mode and fluorescence imaging mode using one or more switches.

20. The method of claim 15, wherein a first movable beam splitter of the one or more movable beam splitters is actuated for fluorescence imaging and for edge filtering in Raman imaging.
